(19) United States
(12) Patent Application Publication
(10) Pub. No.: US 2018/0018593 A1
(43) Pub. Date: Jan. 18, 2018

(54) EXPEDITED IDENTIFICATION VERIFICATION AND BIOMETRIC MONITORING

(71) Applicant: International Business Machines Corporation, Armonk, NY (US)

(72) Inventors: Marco A. Benavides, Carrolltown, TX (US); Stephanie De La Fuente, Lewisville, TX (US); Gregory S. Jones, Lewisville, TX (US)

(21) Appl. No.: 15/212,112

(22) Filed: Jul. 15, 2016

(51) Int. Cl. G06Q 10/02; G08B 21/02; G06F 17/30; G08B 21/18

(52) U.S. Cl. CPC G06Q 10/02; G08B 21/182; G08B 21/0288; G06F 17/30867; G08B 21/0211; G08B 21/0227

(57) ABSTRACT

Systems and methods of the present invention provide for one or more server computers communicatively coupled to a network and configured to: receive a request to purchase admission to an event at a specific venue, a user identification of the user requesting admission and the user's payment method, and a device identifier associated with the user and transmitting the user location; store the request, user/payment data and device identifier in a database; receive, from a sensor within a specific location in the venue, a notification of the device within a proximity to the sensor; and update the payment method to reflect a deduction of the price for the event as determined by the location in proximity to the sensor.

### BACKGROUND

The present invention relates to providing expedited identification verification and biometric monitoring. Currently, users purchase admission to an event, or to some form of public transportation, such as an airplane or a bus, by exchanging currency for a physical ticket. On arrival at the venue for the event, such as a sports arena, or the boarding gate for an airplane, the customer is expected to present the customer's physical ticket to gain admission. Security required for such admission, if it exists at all, usually depends on the customer producing some form of identification, and/or some sort of physical inspection of the person, including the customer's health. Once the ticket has been presented, and the security inspection is complete, the customer is granted admission to the venue.

### SUMMARY

According to some embodiments of the present invention, systems and methods are described for providing expedited identification verification, a check of individual health as well as monitoring potential concerns based on biometric readings before boarding public transportation. Wearable sensors are available which can uniquely identify the person wearing a wearable technology, expedite boarding of public transportation as well as provide basic health information, such as temperature and blood pressure. These devices can provide additional identification security, monitor for persons who may have health anomalies, and even identify elevated anxiety levels based on biometric measurements possibly indicating a concern to public transportation.

These embodiments are based on the ability of persons to wear sensors to identify the persons and provide basic health information. This technology can provide public safety officials with a method to use such sensors to check individuals for conditions such as high temperatures as well as give passengers a unique identifier while using public transportation. This method could significantly improve public safety for persons flying in passenger airplanes along with similar safety for persons traveling in boats or in ground transportation such as trains or buses.

Individuals using public transportation would be issued a wearable, uniquely identified device such as a smart bracelet. This smart bracelet would be issued at a ticketing counter and would be associated with the passenger along with the ticketing information related to travel time, date, boarding time and which airplane, boat, bus or train the passenger has purchased travel for. The person would be required to wear this bracelet to the boarding gate or location. If a security checkpoint were in place, the passenger's smart bracelet would be read to verify that the passenger is in the proper, permitted gate location within the allowed time-frame for the scheduled departure. Health checks would be made at this point to see if the passenger has an elevated temperature indicated a possible biometric anomaly causing concern. The smart bracelet could also check blood pressure and heart rate. This may indicate high anxiety levels for a passenger, which could indicate a safety concern. In all cases related to health checks, security personnel would be alerted for further checks of individuals that have measurements beyond specific thresholds. High anxiety measurements could indicate a concern in the form of illegal substances or items contained on the individual or in the individual's luggage. This could signal a need to thoroughly search the individuals as well as all items that the individuals were carrying. This could lead to further medical tests to verify the individual for any biometric anomalies causing concerns, which could easily be spread in crowded public transportation.

Once boarded on public transportation, onboard readers could quickly scan to verify all scheduled passengers have boarded. If any scheduled passengers are missing, notifications could be sent to the individual via text message or phone call to another smart device registered to the passenger or to the passenger's smart bracelet directly indicating that the passenger is about to miss the passenger's departure.

Once the public transportation has reached the intended destination, the bracelets would be surrendered which verifies the passenger has used the passenger's purchased travel and has reached the passenger's destination.

According to some embodiments of the present invention, one or more server computers communicatively coupled to a network are configured to: receive a request to purchase admission to an event at a specific venue, a user identification of the user requesting admission and the user's payment method, and a device identifier associated with the user and transmitting the user location; store the request, user/payment data and device identifier in a database; receive, from a sensor within a specific location in the venue, a notification of the device within a proximity to the sensor; and update the payment method to reflect a deduction of the price for the event as determined by the location in proximity to the sensor.

### BRIEF DESCRIPTION OF THE DRAWINGS

FIG. 1 illustrates a possible system for expedited identification verification and biometric monitoring.

FIG. 2 is a flow diagram illustrating a possible embodiment of expedited identification verification and biometric monitoring.

FIG. 3 is a flow diagram illustrating a possible embodiment of expedited identification verification and biometric monitoring.

FIG. 4 is an example embodiment including a user interface used in expedited identification verification and biometric monitoring.

FIG. 5 is an example embodiment including a user interface used in expedited identification verification and biometric monitoring.

FIG. 6 is an example embodiment including a user interface used in expedited identification verification and biometric monitoring.

FIG. 7 illustrates a possible system for expedited identification verification and biometric monitoring.

### DETAILED DESCRIPTION

At the core of maintaining public safety and stability is the task of adequately identifying a person that meets some defined criteria, the criteria based on behavioral pattern recognition and situational awareness; tasks that have become increasingly difficult in rapidly evolving security landscapes.

As techniques to evade security systems continue to evolve, public safety agencies work to decrease the predictability of patrol methods. However, a large part of the process of identifying persons meeting the defined criteria relies on human reasoning and cognition. This approach tends to be ineffective and error prone.

It therefore becomes necessary to improve on the success rate and effectiveness of public safety systems. Considering evolving situational landscapes, it is also important to develop intelligent systems that adapt to changes in human behavior and identify anomalies in the defined criteria as the defined criteria evolves. However, currently, there is no intelligent system that provides the ability to understand the learned behavior of public system users, based on past learned behaviors of its users.

Embodiments and aspects of the current invention, therefore, focus on enhancing the capabilities of current public safety systems through the use of wearable and non-wearable Internet of Things (JOT) devices to provide a contextualized environment for public safety officials. The embodiments and aspects described below describe an intelligent system and method to improve the predictability of the identification of anomalies in the defined criteria.

Improving the anomaly identification capability of current systems requires a system that also enhances the user experience by expediting the verification of individual identification; and entrance, navigation, and exit of public transportation or public venues. This is not possible with current systems or methods.

The current embodiments and aspects, therefore, address systems and methods that utilize several inputs to identify anomalies in the defined criteria based on behavioral pattern recognition and situational awareness. These embodiments and aspects are based on an individual's ability to wear sensors to identify the individuals and provide basic information. With the ability to uniquely identify the person wearing the sensor, the device can be used to identify anomalies in varying situations, including as a boarding pass for public transportation, locating lost family members in public spaces, and a complement to identification when crossing international borders.

The wearable system retains historical travel information and public record information in addition to a person's basic health information. The historical travel information and health readings are stored in a repository for analysis to learn trends and detect anomalies.

This technology can provide transportation entities an automated boarding pass system as well as provide public safety officials with a method to use such sensors to check individuals for conditions such as high temperatures. This system also gives passengers a unique identifier while using public transportation.

Once a person purchases passage on an airplane, boat, bus, or train, the person would be issued a bracelet or other wearable device that contains a unique identifier, body readings including temperature and blood pressure. This system also has the capability of recording travel history. If previous travel history and analysis identify one or more anomalies associated with the passenger, the passenger is denied the purchase of a ticket. The determination of such anomalies can be attained through the analysis of varying sets of data including public record information, health readings information, and travel history.

Additionally, the system may also make use of identity analytics solutions to enhance the ability to identify anomalies by identifying each individual's relationship to other known anomalies listed on the organization's records.

The method and systems for identification, ticketing, and safety verification using intelligent wearable technology has several advantages, including: uniquely identifying the person wearing the sensor; supplementing or replacing purchased tickets; expediting the entrance of public transportation or public venues; providing the person's temperature, blood pressure, and other basic health information; providing additional identification security; monitoring for persons who may be sick; and identifying elevated levels of anxiety based on biometric measurements.

In some embodiments, individuals using public transportation or public venues would be issued a wearable, uniquely identified device such as a smart bracelet. This smart bracelet would be issued at a ticketing counter and would be associated with the individual along with the ticketing information related to date, time, location, and/or venue in which the individual has purchased the ticket for. The person would be required to wear this bracelet to the boarding gate or location. If a security checkpoint were in place, the individual's smart bracelet would be read to verify that the individual is in the proper, permitted location within the allowed timeframe for the scheduled departure or event. Business rules in place would alert security personnel if the individual is not at a proper location for scheduled travel/event or within a reasonable time frame of departure or start of event.

Health checks would be made at this point to see if the individual has an elevated temperature indicating a possible health concern. The smart bracelet could also check blood pressure and heart rate. This may indicate high anxiety levels for a passenger, which could indicate an anomaly as described above. In all cases related to health checks, security personnel would be alerted for further checks of individuals that have measurements beyond specific thresholds. High anxiety measurements could indicate a concern in the form of unapproved items contained on the individual or in the individual's luggage. This could signal a need to thoroughly search the individuals as well as all items that the individuals were carrying. This could lead to further medical tests to verify the individual for any health concerns, which could easily be spread in crowded public transportation.

The disclosed embodiments and aspects utilize several inputs to identify the anomalies described above. Detection of vitals cannot accomplish this alone. However, when vital detection technology incorporates the ability to detect abnormal activity, the existing methods are enhanced.

The current method of analyzing user movements through human eyes makes the system prone to user error. However, this system is sending the inputs to the system to algorithmically determine the probability of anomalies in an automated fashion. This improves the quality of public transportation as well as expedites the screening of passengers.

This would save time for security as it would automate the verification of boarding passes, and eliminate the need to print boarding passes. Once at the loading point for airplane, boat, bus or train, for example, the wearable devices for passengers would be automatically scanned as the passengers were boarding. Notifications could be programmed to occur when the passengers are boarding the incorrect vehicle or simply if the passengers are boarding out of scheduled order, time or group.

Furthermore, restrictions could be implemented so that persons having a body temperature or blood pressure above a specified threshold would set off notifications when attempting to pass through security points or boarding public transportation. This could help reduce the spread of illnesses or other medical anomalies and signal a need to further verify an individual passenger with high anxiety levels in crowded public transportation.

Once boarded on public transportation, passengers can continue to be monitored for health indicators as well as ensuring that the passengers are located in the proper location in the transportation vehicle. Again, after exiting from public transportation, passengers would again be monitored for health indicators showing high anxiety.

The system is also capable of learning, as it is taking input from a wide range of users. Learning is vital because individual passengers can learn to keep calm or can learn to act differently upon discovering this system exists, similar to how unscrupulous persons today are constantly changing the unscrupulous persons' methods. Even being too calm can be seen as an anomaly. This system is able to see what stands out as far as vital readings that prove to be average and normal for most passengers on public transportation.

The system would also store previously recorded behavior to determine what is considered normal and abnormal for each individual passenger. This can eliminate errors, further expediting the transportation process, when specific passengers do not have readings that are considered normal and average to the general population, but yet are normal and average to the passenger as an individual.

Additionally, identity analytics solutions such as Identity Insight may be used to identify individual's relationship to other known anomalies. Degrees of separation to other anomalies may also be analyzed to identify possible relationships to the existing anomaly and address the likelihood of the current individuals being analyzed. Identity analytics solutions also provide the ability to analyze the likelihood that the individual being analyzed may be attempting to disguise the individual's identity.

The ability to use a wide array of data sets would allow the system to identify possible false-positives and prevent intervention by public safety officials. For example, comparing the sequentially sampled and current biometric readings of individuals with those of nearby individuals, in combination with environment atmospheric data, would provide the system with a data set that would allow the system to calculate a probability of whether the person should be further analyzed by public safety officials. Only abnormalities in the population would be approached by public safety officials to further investigate the likelihood that additional analysis is necessary.

Inputs to the system may include, but are not limited to: GPS; environment atmospheric measurements; vital measurements; proximity sensors to determine what bracelets are close to each other, or seating position (beacons inside public transport to determine location of bracelets inside); travel history (location, dates, etc.), previous detected behavior and vital measurements in travel history; reason for travel (conference, visiting family, etc.).

Once boarded on public transportation, onboard readers could quickly scan to verify all scheduled passengers have boarded. If any scheduled passengers are missing, notifications could be sent to the individual via text message or phone call to another smart device registered to the passenger or to the passenger's smart bracelet directly indicating that the passenger is about to miss the passenger's departure. Furthermore, with the health sensors still active, passengers can again be screened for potential health or anxiety anomalies. Once the public transportation has reached the intended destination, passengers can be verified to be at the passengers' scheduled destination. If a passenger is arriving at a destination via public transportation, the health sensors could indicate such a situation and provide a notification for safety personnel. The bracelets would be surrendered before finally leaving the terminal verifying the passenger has used the passenger's purchased travel and has reached the passenger's destination.

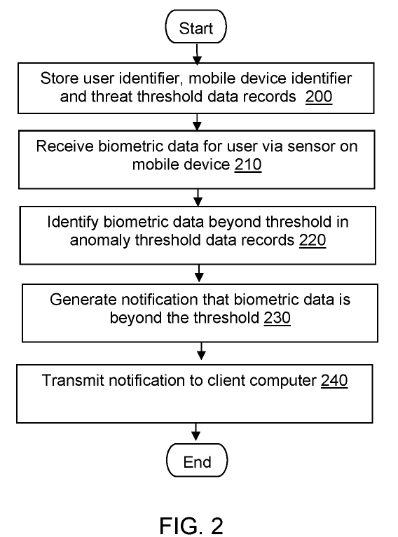

With reference now to FIG. 2, a flowchart is shown, demonstrating the current invention. In this flowchart, server(s) 110 store, within a database coupled to the network: a plurality user data records comprising a user identifier identifying a user and a mobile device identifier identifying a mobile device associated in the database with the user identifier; and a plurality of anomaly threshold data records comprising an anomaly threshold (Step 200); receive, from the mobile device, a transmission encoding a plurality of biometric data for the user received from at least one biometric sensor coupled to the mobile device (Step 210); identify at least one biometric data in the plurality of biometric data beyond at least one anomaly threshold in the plurality of anomaly threshold data records (Step 220); generate a notification that the at least one biometric data is beyond the at least one threshold (Step 230); and transmit the notification to at least one client computer coupled to the network (Step 240).

In some embodiments, these steps may include additional details. For example, in some embodiments and aspects of the present invention, a passenger may create a trip request. Passenger services (e.g., a ticketing agent, gate agent, and/or security at an airport) may gather passenger data. The wearable system may determine if the anomaly is greater than the threshold. If so, passenger services may deny the passenger the ticket, and the method ends. However, if the anomaly is not greater than the threshold, passenger services may link the wearable device with the passenger identity, and issue the wearable device with the ticket information. The passenger may then put on the wearable device with the ticket information, and the wearable system may read and record the passenger's biometric data. The wearable system may then identify and record any anomalies. Otherwise the wearable system may determine whether the anomaly is greater than the threshold. If so, the wearable system may notify the authorities record the data while passenger services deter and/or question the passenger. If not, or after passenger services deters/questions the passenger, the wearable system determines if the passenger is permitted on the vehicle. If not, the passenger is denied boarding and the method ends. Otherwise, the passenger boards the vehicle of transport. The wearable technology may determine whether the vehicle is in motion. If not, the passenger may exit the vehicle of transport. If the vehicle is in motion, the wearable system may read and record biometric data and determine if there are anomalies, and if so record the anomalies. If there are no anomalies, the wearable system may determine if any anomalies are greater than the threshold. If so, the wearable system may notify the authorities, record the anomaly data and apprehend the passenger, and the method ends. Otherwise, the process begins again as the wearable system determines if the vehicle is in motion.

If the vehicle is not in motion and the passenger exits the vehicle of transport, the user may be crossing an international border. If so, the wearable system may determine whether the passenger is waiting to pass customs. If so, the wearable system may read and record biometric data, and determine if there is an anomaly, and record it. If there is no anomaly, the wearable system may determine if the anomaly is greater than the threshold. If so, the wearable system may notify the authorities and record the anomaly data, and passenger services may apprehend the passenger and the method ends. Otherwise, the wearable system returns to the determination of whether the passenger is waiting to pass customs.

If the customer is not waiting to pass customs, the passenger may have checked bags. If not, the passenger may return the wearable device and the method ends. However, if the passenger has checked bags, the wearable system may determine if the passenger is waiting for checked bags. If not, the passenger picks up the passenger's bags, returns the wearable device, and the method ends. However, if the wearable system determines that the passenger is waiting for checked bags, the wearable system may identify and record the biometric data and determine if there is an anomaly, and if so, record it. If there is no anomaly, the wearable system may determine whether an anomaly is greater than the threshold. If so, the wearable system may alert the authorities, record the data and passenger services may apprehend the passenger.

In one example embodiment, the flow begins with the passenger creating a trip request, and this can be done in person or through an online system. The passenger services entity gathers the passenger data to verify that there are no existing anomalies in the passenger record. After analyzing the data and attributes of the customer, a Score is created reflecting anomalies in the data. If the score is larger than the specified threshold, the ticketing agent must deny the ticket to the passenger. This ends a possible flow in the diagram. It should be noted that business rules can be used to specify different thresholds depending on the stage of the trip, i.e. pre-boarding, in-flight, deplaning, etc.

In the case that the score is not larger than the threshold, the ticketing agent will link a wearable device with the passenger identity. For additional security, this can be performed by linking the passenger's fingerprints with the wearable device. The wearable device can also have the passenger ticket information to accelerate passing through security and boarding the plane. In the case that a trip consists of multiple passengers, i.e., a family, each individual passenger would be given the individual passenger's own wearable device linked to the individual passenger's respective fingerprints.

After the passenger puts on the wearable device containing the ticket information, the system reads the passenger's biometric data and records it in a repository. If there is an anomaly in the biometric system, it is recorded. The score is then re-evaluated and compared to the specified threshold. If the score is greater than the specified threshold, the system notifies the authorities and records the data. The passenger services, i.e. security or agents at the gate, would then deter the passenger or ask additional questions. Because this could be a false positive, the system re-evaluates whether the passenger is permitted on the vehicle. If the system permits the passenger onto the vehicle, the passenger can board the vehicle, i.e. plane. If the system does not permit the passenger onto the vehicle, the passenger services, i.e. gate agent, would deny boarding to the passenger. This ends a possible flow.

While the vehicle is in motion, i.e. the flight is in the air, the system reads the passenger's biometric data and records it in a repository. If there is an anomaly in the biometric system, it is recorded. The score is then re-evaluated and compared to the specified threshold. If the score is greater than the specified threshold, the system notifies the authorities and records the data. The passenger services, i.e. flight attendants or Air Marshal, would then apprehend the passenger. If the score is not greater than the threshold and the vehicle is still in motion, the while loop runs again. If the vehicle is no longer in motion, i.e. the plane has landed, the passenger can exit the vehicle of transport, i.e. deplane.

After the passenger deplanes, the passenger must pass through Immigration if the passengers have crossed an international border. While the passenger is in line waiting to go through Customs, the system reads the passenger's biometric data and records it in a repository. If there is an anomaly in the biometric system, it is recorded. The score is then re-evaluated and compared to the specified threshold. If the score is greater than the specified threshold, the system alerts the authorities and records the data. The passenger services, i.e. Immigration agents, would then apprehend the passenger. If the score is not greater than the threshold and the passenger is still waiting to pass Customs, the while loop runs again. If the passenger is no longer waiting in line, i.e. the passenger has passed Customs, the passenger can proceed to Baggage Claim area.

If the passenger has checked bags, the passenger must go to the Baggage Claim area. While the passenger is waiting for his bags at Baggage Claim, the system reads the passenger's biometric data and records it in a repository. If there is an anomaly in the biometric system, it is recorded. The score is then re-evaluated and compared to the specified threshold. If the score is greater than the specified threshold, the system notifies the authorities and records the data. The passenger services, i.e. Baggage Claim agents or TSA agents, would then apprehend the passenger. If the score is not greater than the threshold and the passenger is still waiting for his bags at Baggage Claim, the while loop runs again. If the passenger is no longer waiting in line, i.e. the passenger has acquired his bags, the passenger can return the wearable device to airport agents before exiting the terminal.

In some embodiments, The biometric raw data is taken from the passenger and used as an input into the Wearable System. The passenger is able to look at trip information, the biometric reading, notifications, such as that a family member is looking for the passenger in a terminal or that the passenger's gate has been changed, and the passenger's location within the public area.

The passenger data is stored in a repository and this may include data from the Wearable System such as the passenger's anomaly data, score, biometric reading, and trip information. It also supplies data to the Wearable System such as the anomaly history of the passenger, score history, travel history, biometric history, “fast pass” data, and demographic data.

In the case of an identified anomaly, the Wearable System sends notifications to Security such as details of the notification and the location of the passenger. The location can be the location within a building or the designated seat if the Security is notified while in-flight. The notification of resolution is then sent back to the Wearable System.

The airport or bus station supplies input data to the Wearable System. This data can include the passenger ticket information, the trip request from the passenger, watch list data, and a request for the score history of the passenger to check whether the passenger should be issued a ticket. The airport or bus station then receives, from the Wearable System, the passenger score history, the location from the passenger, the “fast pass” data of the passenger, and the notification.

Multiple examples may demonstrate the utility of the various embodiments of the disclosed invention. In one example, a flight is heading from Dallas to Orlando. The system could include the reason for travel (i.e., Disney World, conference, family, etc.) From analyzing vital measurements, signs may show excitement of passengers to arrive to Disney World. There may be one person who is nervous, but vital signs analyzed by the system would be able to determine whether this is nervousness due to a fear of flying or nervousness due to other motivations. These vital signs could be detected prior to boarding the plane, allowing officials to act accordingly prior to boarding to reduce anxiety of the rest of the passengers. The system would group everyone going to Disney or Sea World and monitor the passengers' behavior, vitals, and seating position.

Another example may include users who travel internationally frequently. Vitals could be measured by the system upon arriving to the destination or when the users are picking up the users' checked baggage. Because the system is storing previously recorded behavior to consider what is normal, and the system notices that on this particular trip (which may be done often), the passenger's vitals are different, the system may flag the anomaly. Human security personnel may determine that the route is a common one for the passengers, and therefore let the passengers go. The health sensors could indicate otherwise. After a situation such as that described above, the system may monitor people closely related or associated with the passengers.

There may be no record of two individuals knowing each other, but due to GPS detection devices on the bracelets, it is possible to know these two individuals were in the same airport and came within inches of the other individual several times during the pre-boarding process at the airport.

A third example may include border patrol checkpoints and crossing of international borders, including driving and flying. In this example, the system may identify drivers/passengers, take vital information, and store it. Every time the drivers/passengers pass the border patrol checkpoints, the drivers′/passengers' vitals are checked. These types of cases may take weather into consideration. For example, if the weather is too hot, the drivers/passengers may be hot. Frequent border/checkpoint crossers could also sign up for a “fast pass” that requires the use of a bracelet.

Intelligent and/or wearable technology, as described above may also have additional utility. Current users may also purchase admission to an event at a specific venue by accessing a user interface, such as a web page configured to receive request and payment information from a user. Non-limiting examples for such a web page may include a web page for purchasing tickets to a sporting event, movie, concert, etc., or a web page for making travel arrangements, such as purchasing airplane tickets. Current users either purchase the tickets on site, or access the web pages described above, purchase the ticket through the web page, and print out the receipt of the purchase for presentation at the venue (e.g., movie theater, ticket boarding counter) at which the event will take place.

Purchasing admission to events (e.g., baseball game, airplane flight) further requires the user to keep track of the ticket for purchase, and present the physical ticket for admission to the event. Furthermore, the physical ticket has no means of tracking the location of the user or monitoring the physical state of the user.

Embodiments and aspects of the disclosed invention represent a significant improvement over current systems and methods. Specifically, the disclosed embodiments utilize one or more server computers, coupled to a network and including one or more processors executing instructions within software algorithms stored in the memory of the server(s). The instructions cause the server(s) to receive and decode transmissions from a UI displayed on a client computer (also coupled to the network), for purchasing admission to an event at a venue (e.g., a sporting event at a stadium, a ticket for public transportation, a movie ticket at a theater, etc.). The server(s) utilize data from the request to associate a specific customer with the purchase of admission, and track the customer's location and/or biometric data related to the event.

Prior to receiving the request, the server(s) may be configured to receive data input by one or more system administrators or other authorized users (system administrators). The server(s) may use this received data to generate and store one or more data records, possibly in one or more data tables, within one or more databases coupled to the network. The data records may identify the venue for the event, or any other venues relevant to the system, as well as one or more venue locations within each venue. For example, each of the data records may define a seat, or a section within the layout of the venue (e.g., concourse level seats, first class seating on an airplane, etc.).

Each of the venue locations, reflected by the data records in the database, may be equipped with sensors capable of detecting and coupling to complimentary devices, such as customer mobile devices described below, in a specific range of proximity. These sensors may be attached to each seat or location (e.g., the entrance to a baseball game, the boarding counter at a specific gate, etc.) within the venue. These sensors may include technology capable of detecting a complimentary running app on a phone or tablet, or a smart chip within the wearable technology, and determine that a device user is within a specific distance of the sensor, thereby determining the location within the venue of a user associated with the device.

For each event taking place at the venue, the server(s) may receive data from the system administrators, and generate and store one or more data records storing a title and/or description of the event, a date and/or time of the event, and an admission price for each of the venue locations within the event.

The user of the system, possibly a customer wanting to purchase admission to the event, may access a customer user interface (UI). As non-limiting examples, this UI may be a web page for purchasing admission to sporting events, music concerts, movies, etc., or may be a web page for creating travel arrangements. The UI may include one or more UI controllers for receiving customer and/or event data including: the customer name, the customer's preferred payment method, a selection of the event, and the user's preferred location within the event, according to the associated purchase price for that venue location. After entering and selecting the associated customer and/or event data, the user may submit the data to the server(s).

The client machine accessed by the user may transmit the data from the UI to the server(s), which may process the data and store it as data records, possibly in one or more data tables, in the database. The stored data may include the user's name and/or a unique identifier (id), the user's payment information, and the details of the event being attended, such as the venue, the geographic location of the venue, the time of the venue (e.g., gates open, boarding time) the user's selected seat or venue location, and the cost of that seat or venue location.

The server(s) may generate and store one or more data records associating the customer's stored data with a location-aware device, possibly including GPS-enabled and/or biometric software applications (apps) on the customer's smart phone or tablet. In some embodiments and aspects of the present invention, such devices may include a wearable technology (e.g., smart watch, biometric sensitive bracelet or wristband containing smart card technology, a smart chip, etc.), either owned by the venue or owned by the user and containing the necessary hardware and software.

On arrival at the venue (e.g., at a will-call or airline gate/boarding counter), if the customer is not already accessing the system using the customer's own device, the venue may provide the customer with the wearable technology, and update the database to reflect the association between the user and the device. The server(s) may begin monitoring data received from the sensor and/or device, and may generate and store data records reflecting the received data in association with the user, including received location and biometric data and the time/date received. The user may use the sensor/device combination to access admission points, thereby eliminating the need for a physical ticket.

The sensors may identify the user's location according to the sensors detecting the customer device, and store data records associating the device with the user's selected location. The server(s) may store within the database, or contain software logic, dictating a set threshold distance between the sensors and any customer device. If the sensor detects the customer device within the threshold distance, the sensor or device may transmit the user's location (base on the proximity data), and the relevant date and time of detection (or loss of signal). The server(s) may generate and store a log of data records reflecting these detected proximity notifications, including identification of the device and sensor location, the proximity between the device and the sensor location, and the start and end times of the proximity notification.

Thus, the server(s) are able to identify the customer/user associated with the customer device using GPS technology and/or complimentary sensors, thereby expediting identification of an individual and admission into an event (e.g., movie, concert, sporting event, boarding of public transportation, etc.). If the individual's position relative to one or more complimentary sensors changes, the entry fee charged to the individual's payment account may be updated and/or pro-rated.

In some embodiments and aspects of the present invention, the data input reflecting the customer's event selection using the customer UI may not include a selection of a location within the venue for the event. In these embodiments, the detection of the proximity between the customer device and the sensors may determine the user's admission purchase price for the event, and may be prorated according to the user's venue location for specific times during the event. For example, if a customer were to arrive at a baseball game and sit in an available seat behind the dugout, the sensor associated with the venue location for the seat would detect the proximity of the customer's device, and transmit the start and end times of the proximity to the server(s), which may select the data records reflecting the appropriate admission price for that seat in the venue location for that event, and generate a deduction from the customer's preferred payment method for that admission price.

In some embodiments and aspects of the present invention, the admission purchase price for the event may be prorated according to the amount of time that the user's device is detected in proximity to specific venue locations during the event. The sensors in different locations may transmit the start and end times that the customer device is within the threshold proximity of the sensor, and the device and/or sensor may transmit this data to the server(s), which may generate and store the transmitted data within the appropriate data records. Based on the transmitted start and end times, the servers may generate a deduction to the customer's preferred payment method, the deduction reflecting the percentage of time at each location. Using the baseball example above, if the sensor within a concourse level seat detected the user device in the threshold proximity for the first 6 innings of the baseball game, and the sensor at field level seat behind the dugout detected the customer device during the last 3 innings, ˜66% of the total charge would be based on pricing for the concourse level seat and ˜33% based on the field level seat.

In some embodiments and aspects of the current invention, the server(s) may keep a series of data records of the events and locations where sensors detected the customer device. In embodiments where the customer runs an app on the customer's mobile device, the log of the customer's geographic locations may be even more comprehensive. The server(s) may analyze this log of geographic user locations to extrapolate and, possibly through machine learning techniques known in the art, determine user patterns of behavior (e.g., customer attends all home baseball games and would therefore be interested in season tickets) These customer behavior patterns, as well as patterns derived from all users generally, may also have marketing applications (e.g., cross selling with restaurants in venues at sporting events).

The detected proximity between the sensors and the customer device, as well as the generated and stored data records of the proximity, may also have customer service applications. For example, if the customer has purchased an airplane ticket, the sensor at a boarding gate may detect that a customer's device is currently in much closer proximity to an incorrect gate than to the correct gate. The server(s) may therefore generate and transmit an alert to the boarding gate personnel for the incorrect gate to assist the customer in determining the source of the error (e.g., a gate or flight time change), and direct the user to the correct gate at the appropriate time. If the data records associated with the customer indicate a pattern of consistent errors, the server may apply logic which applies security applications as well. For example, if the server(s)′ logic determines that a customer's data records reflect a consistent pattern of errors for that customer, the server(s) may generate and transmit an alert to security personnel, flagging the customer for more heightened security at security checkpoints, such as airport security or border crossings.

In embodiments where the customer device includes a display, the server may generate and transmit notifications to the user via the display. For example, based on the customer's behavior patterns noted above, server(s) may generate and transmit messages for season tickets, cross selling, etc., or may display information (e.g., the flight time/gate changes described above) when the sensor detects the customer, etc. Using the example above, if the device detects that the user is moving to a gate other than the gate for which the ticket was purchased, or if there was a gate or time change, the server(s) may transmit a notification for display on the device informing the customer of the incorrect gate/time change and/or instructions to the correct gate.

In some embodiments and aspects of the current invention, the device may monitor a user's biometrics, such as a heart rate or temperature. In these embodiments, the biometric data may be transmitted to the server(s) for storage and analysis, and data records of the biometric and the time of the biometric may be stored and analyzed by the server(s). Similar to the user purchase patterns above, the server(s) may detect patterns and normal ranges for the user's biometrics (and in all users generally). The server(s) may then analyze new incoming biometric data from the device and compare it to the data records for all users generally and the current user specifically. If the user is a new user, and the biometric levels are out of range for the general users, or if there is previous biometric data for that user and the biometric levels are currently out of range for that user (e.g., high temperature, high blood pressure), the server(s) may identify the anomaly and transmit alerts to the appropriate venue (e.g., boarding agents) to allow the boarding agents to assist the user in finding appropriate medical assistance. These anomalies may also have security applications (e.g., possible illness spread in confined space, lie detector type notification).

Thus, the present invention also monitors the individual's biometric readings (e.g., temperature, blood pressure) and, where applicable, location history, to identify health (e.g., highly contagious) and/or safety (e.g., anxiety due to possible public safety) concerns. In some embodiments, the customer may permanently wear the wearable device, and therefore provide a constant stream of location and/or biometric data about the customer.

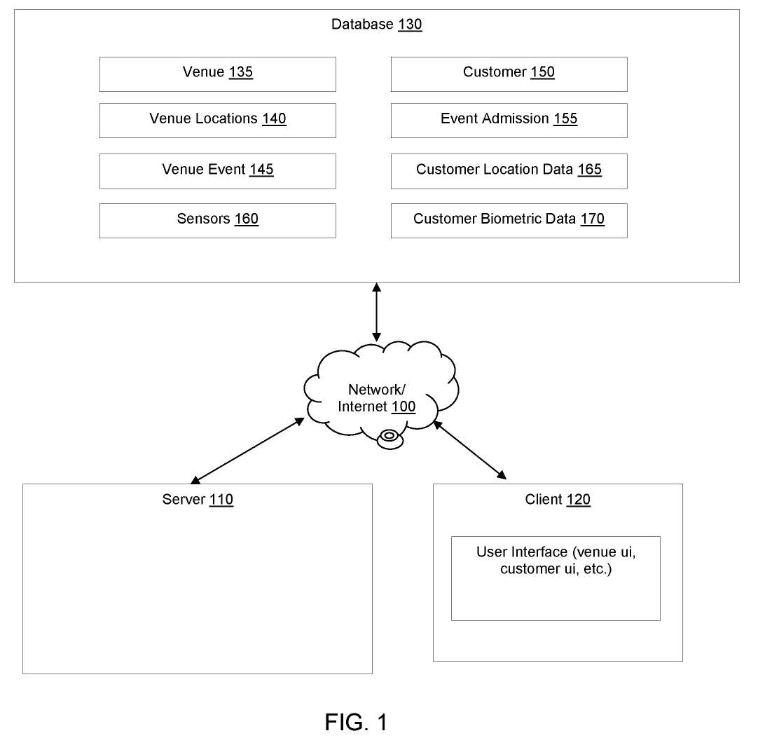

With reference now to FIG. 1 the present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices (e.g., server(s) 110) from a computer readable storage medium or to an external computer or external storage device via a network 100, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device (e.g., server(s) 110, client(s) 120) receives computer readable program instructions from the network 100 and forwards the computer readable program instructions for storage in a computer readable storage medium within the respective computing/processing device 110, 120.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer 110, 120, partly on the user's computer 110, 120, as a stand-alone software package, partly on the user's computer 110, 120 and partly on a remote computer 120 or entirely on the remote computer or server 110. In the latter scenario, the remote computer 120 may be connected to the user's computer through any type of network 100, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

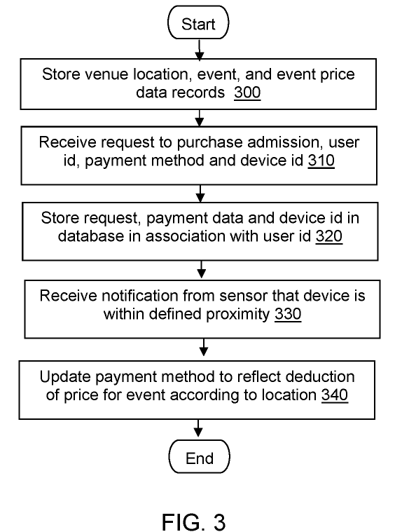

With reference now to FIG. 3, a flowchart is shown, demonstrating the current invention. In this flowchart, server(s) 110 store, within a database coupled to a network: at least one location data record storing a location within a venue; at least one event data record storing an event scheduled to take place at the venue; and at least one event price data record storing a price associating the location in the at least one location data record with the event in the at least one event data record (Step 300); Server(s) 110 then receive, from a user interface on a client computer coupled to the network, a transmission encoding: a request to purchase admission to the event at the venue; a user identifier identifying a user transmitting the request; a payment method to be charged to the user for the event; and a device identifier identifying a device transmitting a current location of the user and associated in the database with the user identifier (Step 310). Server(s) 110 then store, within the database, in association with the user identifier, the request, the payment data and the device identifier (Step 320). Server(s) 110 then receive, from a sensor at the location within the venue, a notification that the device is within a proximity to the sensor, as defined within the instructions or the database (Step 330). Server(s) 110 then update the payment method for the user to reflect a deduction of the price for the event associated with the location determined by the sensor (Step 340).

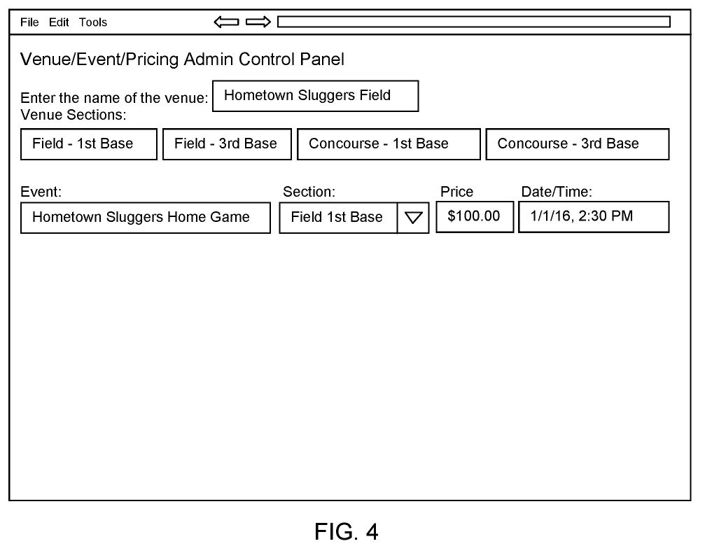

With reference now to FIG. 4, an administrator responsible for maintaining the system on behalf of the venue (venue administrator) may access a venue UI, such as the non-limiting example UI seen in FIG. 4. This venue UI may include one or more UI controllers configured to receive input from the venue administrator. As seen in FIG. 4, the venue UI may include three sections allowing the venue administrator to: input the name and/or physical address of the venue; input one or more locations (e.g., seats) within the venue; and input one or more events taking place at the venue.

As seen in FIG. 4, the UI controllers for inputting the name and location of the venue may include, but are not limited to: one or more venue name/description UI controllers configured to receive input for the name and/or description of the venue; and one or more venue address UI controllers configured to receive input for the physical address of the venue. The UI controllers for inputting the one or more locations within the venue may include, but are not limited to one or more venue location UI controllers configured to receive input describing one or more locations within the venue. The UI controllers for inputting the one or more events taking place at the venue may include, but are not limited to: one or more event name/description UI controllers configured to receive input for the name and/or description of the event; one or more event venue location selection UI controllers configured to receive input selecting one of the locations identified in the venue location UI controllers; one or more event price UI controllers configured to receive a desired admission price for the event within the selected location within the venue; and one or more event date UI controllers configured to receive input of the date and/or time of the event. After the data is input into the provided UI controllers, the user may submit the data. The client computer 120 that displayed the UI may then transmit the input data to the server(s) 110.

Server(s) 110 may receive the transmission, including venue data 135, and store the venue data 135 within a database and/or data storage 130 coupled to the network 100. In some embodiments, the venue within the venue data 135 may be stored within its own data record, in a data table storing subject matter, such as the example data table below.

| ven-id | venue | address |
|---|---|---|
| 1 | Hometeam Sluggers Field | 123 Main St., Hometown USA |
| 2 | Acme Airlines | Acme Airfield, Bldg. 1, Gate 16 |
| . . . | . . . | . . . |

Each data record in this example data table may include: a venue id data field storing a unique id associated with the venue stored within the data record; a venue name/description data field storing the name and/or description of the venue 135; and a venue address data field storing the physical address of the venue.

In the example data table above, server(s) 110 may receive the venue data 135 from the venue UI seen in FIG. 4, and automatically generate and store the data record with a venue id 1, with a name/description “Hometown Sluggers Field,” and with a physical address of “123 Main Street, Hometown USA.” This example venue data table also includes an additional data record subsequently input into, and received from, the venue UI.

The transmission from the venue UI on client computer 120 to server(s) 110 may also include venue location data 140, including one or more locations (e.g., seats, designated areas, etc.) within the venue included in the venue data 135. Server(s) 110 may receive the venue location data 140, and store the venue locations from the venue location data 140 within the database 130. In some embodiments, each of the venue locations identified within the venue location data 140 may be stored within its own data record, in a data table storing one or more venue locations, such as the example data table below.

| loc-id | ven-id | venue-location |
|---|---|---|
| 1 | 1 | Field Seats - 1^{st} Base |
| 2 | 1 | Field Seats - 3^{rd} Base |
| 3 | 1 | Concourse Seats - 1^{st} Base |
| 4 | 1 | Concourse Seats - 3^{rd} Base |
| 5 | 1 | Hometeam Sluggers Field Entrance |
| 6 | 2 | First class seats |
| 7 | 2 | Coach seats |
| 8 | 2 | Sky Harbor Main Entrance |
| . . . | . . . | . . . |

Each data record in this example data table may include: a location id data field storing a unique id associated with the venue location stored within the data record; a venue id data field referencing a data record within the venue data table and identifying a venue associated with the venue location id; and a venue location data field storing the name and/or description of the venue location.

In the example data table above, server(s) 110 may receive the venue location data 140 from the venue UI seen in FIG. 4, and automatically generate and store the data record with venue location ids 1-5, with a venue id referencing venue id 1 (“Hometown Sluggers Field”), and with names/descriptions “Field Seats—1^{st} Base,” “Field Seats—3^{rd} Base,” “Concourse Seats—1^{st} Base,” and “Concourse Seats—3^{rd} Base.” This example venue location data table also includes additional data records subsequently input into, and received from, the venue UI.

The transmission from the venue UI on client computer 120 to server(s) 110 may also include venue event data 145, including one or more events to take place within the venue included in the venue data 135. Server(s) 110 may receive the venue event data 145, and store the venue events from the venue event data 145 within the database 130. In some embodiments, each of the venue events identified within the venue event data 145 may be stored within its own data record, in a data table storing one or more venue events, such as the example data table below.

| ev-id | loc-id | Event | price | Date |
|---|---|---|---|---|
| 1 | 1 | Home Game 1 | 100 | 1/1/16 14:30 |
| 2 | 2 | Flight from Phoenix to Denver | 300 | 5/1/16 15:00 |
| 3 | 2 | Home Game 2 | 30 | 5/1/16 14:30 |
| 4 | 3 | Home Game 3 | 100 | 6/1/16 14:30 |
| . . . | . . . | . . . | . . . | . . . |

Each data record in this example data table may include: an event id data field storing a unique id associated with the venue event stored within the data record; a venue location id data field referencing a data record within the venue location data table and identifying a venue location associated with the venue event id; an event name/description data field storing the name and/or description of the venue event; an event price data field storing the price for the event; and an event date/time data field storing the date and/or time (i.e., start time) for the event.

In the example data table above, server(s) 110 may receive the venue event data 145 from the venue UI seen in FIG. 4, and automatically generate and store the data record with venue event id 1, with a venue location id referencing venue location id 1 (“Field Seats—1^{st} Base”), with an event name/description “Home Game 1,” with an event price of $100 and with an event date/time of 2:30 PM on Jan. 21, 2016.” This example venue event data table also includes additional data records subsequently input into, and received from, the venue UI.

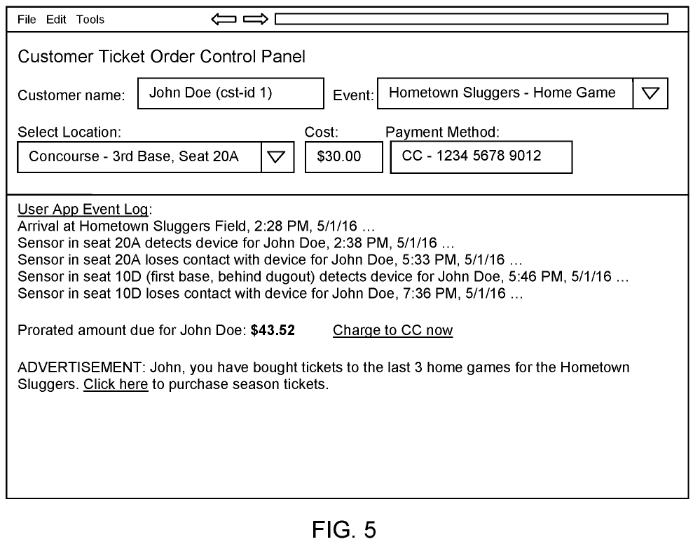

With reference now to FIGS. 4-5, a customer desiring to purchase admission to an event (customer) may access a customer UI, such as the non-limiting example UIs seen in FIGS. 4-5. As non-limiting examples, the type of event the user may want to purchase admission to may comprise a sporting event, entry onto public transportation (e.g., airplane, train, bus, etc.), a music concert, a movie, or any other event where the user is assigned a specific location (e.g., a specific seat) within the venue that benefits the user over other customers (e.g., seats behind the dugout at a baseball game, first class seats on an airplane, orchestra seats, box seats, seats on the field at the 50 yard line at a football game, an area near a stage at a concert or in an arena, movie seats at the center of the theater, etc.).

The customer UI may include one or more UI controllers configured to receive input from the customer. As seen in FIGS. 4-5, these UI controllers may include, but are not limited to: one or more customer name UI controllers configured to receive name and/or customer id data for a customer; one or more event selection UI controllers, populated with the venue event data 145, possibly stored in, and selected from, the venue event data table described above, and configured to receive the customer's selection of the event the customers desire to purchase admission for; one or more venue location selection UI controllers, populated with the venue location data 140, possibly stored in, and selected from, the venue location data table described above, and configured to receive the customer's selection of the customer's preferred venue location at the event; a price UI controller for the event, possibly stored in, and selected from, the associated venue event data record, and configured to display the price of the selected event; and a customer payment method UI controller configured to receive a payment method the customer uses to pay for admission to the selected event. After the data is input into the provided UI controllers, the user may submit the data. The client computer 120 that displayed the UI may then transmit the input data to the server(s) 110.

Server(s) 110 may receive the transmission, including customer data 1xx, and store the customer data 150 within database 130. In some embodiments, the customer within the customer data 150 may be stored within its own data record, in a data table storing the customer information, such as the example data table below.

| cst-id | customer-name | payment-method | device-id |
|---|---|---|---|
| 1 | John Doe | CC - 1234 5678 9012 | xyz-123 |
| 2 | Jane Doe | CC - 5678 9012 3456 | abc-321 |
| . . . | . . . | . . . | . . . |

Each data record in this example data table may include: a customer id data field storing a unique id associated with the customer stored within the data record; a customer name data field storing the name of the customer; a payment method data field storing a payment method, such as a credit card or PAYPAL account, associated with the customer; and a device id data field storing a unique id for a device (e.g., mobile phone, smart bracelet) associated with the customer, described in more detail below.

In the example data table above, server(s) 110 may receive the customer data 150 from the customer UI seen in FIGS. 4-5, and automatically generate and store the data record with a customer id 1, with a name “John Doe,” with a payment method of credit card 1234 5678 9012 and with a device id of xyz-123. This example customer data table also includes an additional data record subsequently input into, and received from, the customer UI.

The transmission from the customer UI on client computer 120 to server(s) 110 may also include event admission data 155, including the data for a customer to purchase admission to an event. Server(s) 110 may receive the event admission data 155, and store the event admission data 155 within the database 130. In some embodiments, each of the admission purchases identified within the event admission data 155 may be stored within its own data record, in a data table storing one or more admission purchases, such as the example data table below.

| adm-id | ev-id | cst-id |
|---|---|---|
| 1 | 1 | 1 |
| 2 | 2 | 2 |
| . . . | . . . | . . . |

Each data record in this example data table may include: an admission id data field storing a unique id associated with the purchase of event admission stored within the data record; an event id data field referencing a data record within the venue event data table and identifying an event for which admission is purchased; and a customer id data field referencing a data record within the customer data table and identifying a customer purchasing admission to the event identified by the event id.

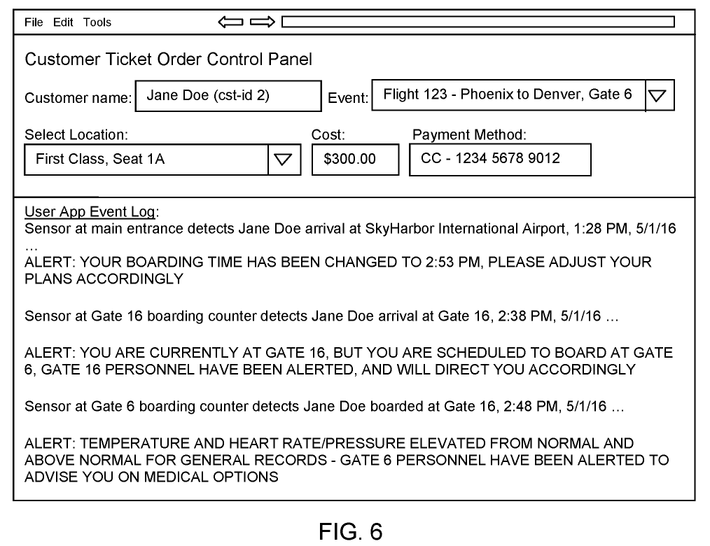

In the example data table above, server(s) 110 may receive the event admission data 155 from the customer UIs seen in FIGS. 4-5, and automatically generate and store the data records. The received data from the customer UI in FIG. 5 may be stored with an admission id 1, with an event id referencing venue event id 1 (“Home Game 1” with tickets for seats on the field behind the 1^{st} base line costing $100 and taking place 1/1/16), and a customer id referencing customer id 1 (“John Doe,” and referencing the associated payment method and unique device id). This example venue event data table also includes an additional data record storing data received from the customer UI in FIG. 6, with an admission id 2, with an event id referencing venue event id 2 (Acme Airlines “Flight from Phoenix to Denver” with tickets for first class seats costing $300 and taking place 5/1/16), and a customer id referencing customer id 2 (“Jane Doe,” including the associated payment method and unique device id).

Each venue location for each event within each venue may include sensors capable of detecting and identifying details for specific complimentary customer devices (e.g., a user's smart phone or a wearable technology such as a smart bracelet, discussed below). The sensors may be affixed to each seat or venue location. For example, a sensor may be affixed to an entrance to a sporting event, a boarding counter at a specific gate at an airport, a specific seat on a plane, train, bus, movie, etc., or to specific positions closest to a stage at a music concert. The sensors may include technology capable of detecting a complimentary running app on a phone or tablet, or a smart chip within the wearable technology, and determine that a device user is within a specific distance of the sensor. The sensor's detection of the customer device may create a temporary coupling between the two devices, in order to determine the user's location within the venue.

The sensors may be coupled to a local network, such as a BLUETOOTH network, and may also be coupled to network 100. These networks may therefore allow the sensors to detect and identify the customer devices through the local network and transmit data about the complimentary devices, such as a user's location(s) and/or biometric data (discussed below) to server(s) 110 for analysis.

In some embodiments and aspects of the present invention, a system administrator and/or venue administrator may access a UI (not shown) configured to identify the details for each of the sensors within each of the venues within the system and transmit the data to server(s) 110. Server(s) 110 may receive the transmission, including sensor data 160, and store the sensor data 160 within database 130. In some embodiments, the sensor information within the sensor data 160 may be stored within its own data record, in a data table storing the sensors, such as the example data table below.

| sns-id | loc-id | proximity threshold |
|---|---|---|
| 1 | 1 | 3 ft. |
| 2 | 5 | 30 ft. |
| 3 | 6 | 3 ft. |
| 4 | 8 | 30 ft. |
| . . . | . . . | . . . |

Each data record in this example data table may include: a sensor id data field storing a unique id associated with the sensor stored within the data record; a venue location id data field referencing a data record within the venue location data table and identifying a unique id for a venue location associated with the sensor, and a proximity threshold defined by the system and/or venue administrator, storing a distance between the sensor and the customer device, that when detected, triggers the transmission of signals and data described below.

In the example data table above, server(s) 110 may receive the sensor data 160 from the system and/or venue administrator UI, and automatically generate and store the data record with a sensor id 1, with a location id referencing venue location id 1 (“Field Seats—1^{st} Base”), and with a proximity threshold of 3 feet. In this example, or example data record 3 above, the sensor may be attached to the stadium or first class seat itself, so that the mobile device is detected and identified, and the data is transmitted through the network(s) 100 only when the user is in close proximity to (i.e., within three feet of) the sensor. By contrast, in data records 2 and 4, the sensor may be attached to a stadium entrance gate or airport main entrance respectively, the customer device may be detected and identified, and the data transmitted through the network(s) 100 when the customer is within a greater proximity, such as 30 feet in these examples.

In some embodiments and aspects of the present invention, the user may operate a smart phone or other mobile device. In some embodiments, the mobile device may include and run technology such as GPS technology capable of determining a user's location. In some embodiments, the mobile device may include and run technology capable of monitoring a user's biometric data, such as heart rate, blood pressure, or temperature. The mobile device may also include and run a software application, or app, configured to transmit signals to, or receive signals from, any of the sensors and/or server(s) 110 through the networks disclosed above.

In some embodiments and aspects of the present invention, the system and/or venue administrator may maintain a collection of wearable technology. As non-limiting examples, such wearable technology may include a smart watch, or a bracelet, wristband, ankle bracelet, etc. containing smart card or smart chip technology. The smart card or smart chip technology may include any known technology including at least one integrated circuit or other processor able to detect, identify, store, transmit, and/or display data for the device. The wearable technology may also include any features described in relation to the user's mobile device above.

On arrival at the venue (e.g., at a will-call or airline gate/boarding counter), if the user is not already accessing the system using the customer's own mobile customer device, a system administrator may provide the customer with the wearable technology and enter the relevant data into an appropriate UI indicating that the administrator has provided the device to the specific customer, thereby associating the customer with the wearable technology, as seen in the customer data records above.

FIGS. 4-5 demonstrate non-limiting examples of the display that may appear on the user's mobile device or possibly on the screen of an integrated display on the wearable technology. For simplicity in demonstrating the embodiments and aspects of the present invention, FIGS. 4-5 have combine the customer UI with the described notification display. However, in other embodiments, the app or wearable device may include only the notification display.

Data from the sensors, user mobile devices and/or wearable technology may be transmitted through the disclosed networks 100 to the server(s) 110, which may begin monitoring data received from these devices and generate a log of data records reflecting the received data in association with the customer and the time/date received, including customer location and biometric data.

Server(s) 110 may receive the transmission(s) from the sensors, mobile devices, and/or wearable technologies, including customer location data 165, and store the customer location data 165 within database 130. In some embodiments, the customer's location within the user location data 165 may be stored within its own data record, in a data table storing the customer location information, such as the example data table below.

| uloc-id | sns-id | cst-id | uloc-type | date-time |
|---|---|---|---|---|
| 1 | 2 | 1 | detect | 5/1/16 14:28 |
| 2 | 4 | 2 | lose contact | 5/1/16 13:28 |
| . . . | . . . | . . . | . . . | . . . |

Each data record in this example data table may include: a user location id data field storing a unique id associated with the user location stored within the data record; a sensor id data field referencing a data record within the sensor data table and identifying a sensor triggering the data transmission; a customer id data field referencing a data record within the customer data table and identifying the customer/customer device that triggered the data transmission; a user location type data field storing the type of detection of the customer's location (e.g., sensor detects customer device, sensor loses contact with customer device); and a customer location date/time data field storing the date and/or time that the user location of user location type was detected.

In the example data table above, server(s) 110 may receive the customer location data 165 from the sensors, mobile devices, and/or wearable technologies, as demonstrated in the UI in FIG. 5, and automatically generate and store the data record with a customer location id 1, with a user location type of “detect” from sensor id 2 (“Hometown Sluggers Field Entrance”) at 2:28 PM on May 1, for customer id 1 (“John Doe”). This example customer location data table may also include additional data records subsequently input into, and received from, the sensors, described in more detail below.

In some embodiments and aspects of the current invention, the customer's mobile device(s) and/or wearable technology may include hardware and/or software configured to monitor a user's biometric data 170, such as a heart rate, blood pressure, or temperature. In these embodiments, the mobile device(s) and/or wearable technology may transmit the detected biometric data 170 through the disclosed networks to server(s) 110 for storage and analysis, and server(s) 110 may monitor, analyze, and store biometric data received from the devices, and generate a log of data records reflecting the received biometric data 170 in association with the customer, including the biometric data 170 and the time/date received.

Server(s) 110 may receive the transmission(s) from the hardware and/or software monitoring the customer's biometrics, including user biometric data 170, and store the customer biometrics data 170 within database 130. In some embodiments, the customer's biometric within the customer biometric data 170 may be stored within its own data record, in a data table storing the customer biometric information, such as the example data table below.

| bio-id | cst-id | bio-type | metric | date-time |
|---|---|---|---|---|
| 1 | 2 | temperature | 102 | 5/1/16 14:38 |
| . . . | . . . | . . . | | . . . |

Each data record in this example data table may include: a customer biometric id data field storing a unique id associated with the customer biometric stored within the data record; a customer id data field referencing a data record within the customer data table; a biometric type data field storing the type of biometric in the data field, such as a customer's temperature; a metric data field measuring the biometric, such as the degrees in Fahrenheit for the customer's temperature; and a customer biometric date/time data field storing the date and/or time that the customer biometric was detected.

In the example data table above, server(s) 110 may receive the customer biometric data 170 from the mobile devices, and/or wearable technologies, as demonstrated in the UI in FIG. 6, and automatically generate and store the data record with a customer biometric id 2, detecting the user's temperature as 102 degrees on at 2:28 PM on May 1, for customer id 2 (“Jane Doe”). This example customer biometric data table may also include additional data records subsequently input into, and received from, the devices' hardware and software.

The customer data, such as the location and biometric data received by server(s) 110 from the sensors, may customize the customer experience. For example, in some embodiments and aspects of the present invention, software logic within server(s) 110 may prorate the admission purchase price for the event according to the amount of time that the customer's device is detected in proximity to specific venue locations during the event. The sensors in different locations may transmit the start and end times that the customer device is within the threshold proximity of the sensor, and the device and/or server may transmit this data to server(s) 110, which may generate and store the transmitted data within the appropriate data records. Based on the transmitted start and end times, servers 110 may generate a deduction to the customer's preferred payment method, the deduction reflecting the percentage of time at each location. Using the example from FIG. 5, if the sensor within a concourse level seat detected the user device in the threshold proximity for the first 6 innings of the baseball game, and the sensor at field level seat behind the dugout detected the customer device during the last 3 innings, ˜66% of the total charge would be based on pricing for the concourse level seat and ˜33% based on the field level seat.

In some embodiments and aspects of the current invention, the server(s) may keep a series of data records of the events and locations where sensors detected the customer device. In embodiments where the customer runs an app on the customer's mobile device, the log of the customer's geographic locations may be even more comprehensive. The server(s) may analyze this log of geographic user locations to extrapolate and, possibly, through machine learning techniques known in the art, determine customer patterns of behavior (e.g., customer attends all home baseball games and would therefore be interested in season tickets, as seen in FIG. 5) These customer behavior patterns, as well as patterns derived from all customers generally, may also have marketing applications (e.g., cross selling with restaurants in venues at sporting events).

The detected proximity between the sensors and the customer device, as well as the generated and stored data records of the proximity, may also have customer service applications. For example, if the customer has purchased an airplane ticket, the sensor at a boarding gate (e.g., gate 16 in FIG. 6) may detect that a customer's device is currently in much closer proximity to an incorrect gate than to the correct gate. The server(s) may therefore generate and transmit an alert to the boarding gate personnel for the incorrect gate, as seen in FIG. 6, to assist the customer in determining the source of the error (e.g., a gate or flight time change), and direct the user to the correct gate at the appropriate time.

If the data records associated with the customer indicate a pattern of consistent errors, server(s) 110 may apply software logic which applies security applications as well. For example, if server(s)′ 110 logic determines that a customer's data records reflect a consistent pattern of errors for that customer, the server(s) may generate and transmit an alert to security personnel, flagging the customer for more heightened security at security checkpoints, such as airport security or border crossings.

As seen in FIGS. 4-5, in embodiments where the customer device includes a display, server(s) 110 may generate and transmit notifications to the user via the display. For example, based on the customer's behavior patterns noted above, server(s) may generate and transmit messages for season tickets, cross selling, etc., or may display information (e.g., the flight time/gate changes described above) when the sensor detects the customer, etc. Using the example in FIG. 6, if the device detects that the user is moving to a gate other than the gate for which the ticket was purchased, or if there was a gate or time change, the server(s) may transmit a notification for display on the device informing the customer of the incorrect gate/time change and/or instructions to the correct gate. (OR determine if the customer is on board at the appropriate time, and if not, send an alert that the customer is about to miss the event.)

In some embodiments and aspects of the current invention, the device may monitor a user's biometrics, such as a heart rate or temperature. In these embodiments, the biometric data may be transmitted to the server(s) for storage and analysis, and data records of the biometric and the time of the biometric may be stored and analyzed by the server(s). Similar to the user purchase patterns above, the server(s) may detect patterns and normal ranges for the user's biometrics (and in all users generally). The server(s) may then analyze new incoming biometric data from the device and compare it to the data records for all users generally and the current user specifically. If the user is a new user, and the biometric levels are out of range for the general users, or if there is previous biometric data for that user and the biometric levels are currently out of range for that user (e.g., high temperature, high blood pressure), the server(s) may identify the anomaly and transmit alerts to the appropriate venue (e.g., boarding agents) to allow the boarding agents to assist the user in finding appropriate medical assistance. These anomalies may also have security applications (e.g., possible illness spread in confined space, lie detector type notification).

Thus, the present invention also monitors the individual's biometric readings (e.g., temperature, blood pressure) and, where applicable, location history, to identify health (e.g., highly contagious) and/or safety (e.g., anxiety due to possible public safety) concerns. In some embodiments, the customer may permanently wear the wearable device, and therefore provide a constant stream of location and/or biometric data about the customer.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

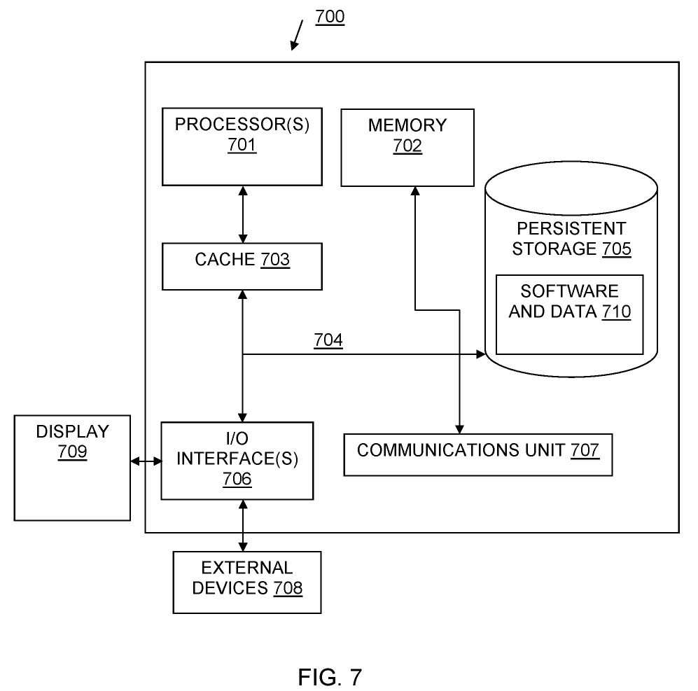

FIG. 7 depicts computer system 700, which is representative of client device 120 and server 110, in accordance with an illustrative embodiment of the present invention. It should be appreciated that FIG. 7 provides only an illustration of one implementation and does not imply any limitations with regard to the environments in which different embodiments may be implemented. Computer system 700 includes processor(s) 701, cache 703, memory 702, persistent storage 705, communications unit 707, input/output (I/O) interface(s) 706, and communications fabric 704. Communications fabric 704 provides communications between cache 703, memory 702, persistent storage 705, communications unit 707, and input/output (I/O) interface(s) 706. Communications fabric 704 can be implemented with any architecture designed for passing data and/or control information between processors (such as microprocessors, communications and network processors, etc.), system memory, peripheral devices, and any other hardware components within a system. For example, communications fabric 704 can be implemented with one or more buses or a crossbar switch.

Memory 702 and persistent storage 705 are computer readable storage media. In this embodiment, memory 702 includes random access memory (RAM). In general, memory 702 can include any suitable volatile or non-volatile computer readable storage media. Cache 703 is a fast memory that enhances the performance of processor(s) 701 by holding recently accessed data, and data near recently accessed data, from memory 702.

Program instructions and data (e.g., software and data 710) used to practice embodiments of the present invention may be stored in persistent storage 705 and in memory 702 for execution by one or more of the respective processor(s) 701 via cache 703. In an embodiment, persistent storage 705 includes a magnetic hard disk drive. Alternatively, or in addition to a magnetic hard disk drive, persistent storage 705 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 705 may also be removable. For example, a removable hard drive may be used for persistent storage 705. Other examples include optical and magnetic disks, thumb drives, and smart cards that are inserted into a drive for transfer onto another computer readable storage medium that is also part of persistent storage 705. Software and data 710 can be stored in persistent storage 705 for access and/or execution by one or more of the respective processor(s) 701 via cache 703. With respect to client device 120, software and data 710 includes application management programs and applications.

Communications unit 707, in these examples, provides for communications with other data processing systems or devices. In these examples, communications unit 707 includes one or more network interface cards. Communications unit 707 may provide communications through the use of either or both physical and wireless communications links. Program instructions and data (e.g., software and data 710) used to practice embodiments of the present invention may be downloaded to persistent storage 705 through communications unit 707.

I/O interface(s) 706 allows for input and output of data with other devices that may be connected to each computer system. For example, I/O interface(s) 706 may provide a connection to external device(s) 708, such as a keyboard, a keypad, a touch screen, and/or some other suitable input device. External device(s) 708 can also include portable computer readable storage media, such as, for example, thumb drives, portable optical or magnetic disks, and memory cards. Program instructions and data (e.g., software and data 710) used to practice embodiments of the present invention can be stored on such portable computer readable storage media and can be loaded onto persistent storage 705 via I/O interface(s) 706. I/O interface(s) 606 also connect to display 709.

Display 709 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

What is claimed is:

1. A system comprising at least one processor executing instructions within an active memory operatively coupled to a server computer operatively coupled to a network, the instructions causing the server computer to:
store, within a database coupled to the network:
a plurality user data records comprising a user identifier identifying a user and a mobile device identifier identifying a mobile device associated in the database with the user identifier; and
a plurality of anomaly threshold data records comprising an anomaly threshold;
receive, from the mobile device, a transmission encoding a plurality of biometric data for the user received from at least one biometric sensor coupled to the mobile device;
identify at least one biometric data in the plurality of biometric data beyond at least one anomaly threshold in the plurality of anomaly threshold data records;
generate a notification that the at least one biometric data is beyond the at least one threshold; and
transmit the notification to at least one client computer coupled to the network.

2. A system comprising at least one processor executing instructions within an active memory operatively coupled to a server computer operatively coupled to a network, the instructions causing the server computer to:
store, within a database coupled to the network:
at least one location data record storing a location within a venue;
at least one event data record storing an event scheduled to take place at the venue; and
at least one event price data record storing a price associating the location in the at least one location data record with the event in the at least one event data record;
receive, from a user interface on a client computer coupled to the network, a transmission encoding:
a request to purchase admission to the event at the venue;
a user identifier identifying a user transmitting the request;
a payment method to be charged to the user for the event; and
a device identifier identifying a device transmitting a current location of the user and associated in the database with the user identifier;
store, within the database, in association with the user identifier, the request, the payment data and the device identifier;
receive, from a sensor at the location within the venue, a notification that the device is within a proximity to the sensor, as defined within the instructions or the database; and
update the payment method for the user to reflect a deduction of the price for the event associated with the location determined by the sensor.

3. The system of claim 2, wherein the device is selected from the group consisting of:
a wearable technology comprising a smart chip comprising at least one embedded integrated circuit; and
a software application on a mobile device configured to access a global positioning system (GPS) technology for determining the proximity of the mobile device to the sensor.

4. The system of claim 2, wherein:
the venue is selected from the group consisting of a sports arena, an airplane, a train, a bus, a movie theater, a music hall, or a music arena; and
the location comprises a seat or a section within the venue.

5. The system of claim 2, wherein the notification comprises a first time period between a first start time and a first end time that the device was within the proximity.

6. The system of claim 5, wherein the instructions cause the server computer to:
receive, from a second sensor at a second location, a second notification that the device is within a second proximity of a second sensor during a second time period; and
update the payment method to prorate the deduction of the price for the event according to the first time period and the second time period.

7. The system of claim 2, wherein the instructions further cause the server computer to generate and store a plurality of user pattern data records comprising a plurality of events associated with a plurality of geographic locations.

8. The system of claim 7, wherein the instructions further cause the server computer to generate and transmit at least one advertisement according to the user pattern data.

9. The system of claim 7, wherein the instructions further cause the server computer to generate and transmit at least one customer service instruction according to the user pattern data.

10. The system of claim 2, wherein the instructions further cause the server computer to generate and store a plurality of user biometric data records comprising a log of biometric data for the user.

11. A method comprising the steps of:
storing, by a server computer operatively coupled to a network and comprising at least one processor executing instructions within an active memory operatively coupled to the server computer, within a database coupled to the network:
at least one location data record storing a location within a venue;
at least one event data record storing an event scheduled to take place at the venue; and
at least one event price data record storing a price associating the location in the at least one location data record with the event in the at least one event data record;
receiving, by the server computer, from a user interface on a client computer coupled to the network, a transmission encoding:
a request to purchase admission to the event at the venue;
a user identifier identifying a user transmitting the request;
a payment method to be charged to the user for the event; and
a device identifier identifying a device transmitting a current location of the user and associated in the database with the user identifier;
storing, by the server computer, within the database, in association with the user identifier, the request, the payment data and the device identifier;
receiving, by the server computer, from a sensor at the location within the venue, a notification that the device is within a proximity to the sensor, as defined within the instructions or the database; and
updating, by the server computer, the payment method for the user to reflect a deduction of the price for the event associated with the location determined by the sensor.

12. The method of claim 11, wherein the device is selected from the group consisting of:
a wearable technology comprising a smart chip comprising at least one embedded integrated circuit; and
a software application on a mobile device configured to access a global positioning system (GPS) technology for determining the proximity of the mobile device to the sensor.

13. The method of claim 1, wherein:
the venue is selected from the group consisting of a sports arena, an airplane, a train, a bus, a movie theater, a music hall, or a music arena; and
the location comprises a seat or a section within the venue.

14. The method of claim 11, wherein the notification comprises a first time period between a first start time and a first end time that the device was within the proximity.

15. The method of claim 14, further comprising the steps of:
receiving, by the server computer, from a second sensor at a second location, a second notification that the device is within a second proximity of a second sensor during a second time period; and
updating, by the server computer, the payment method to prorate the deduction of the price for the event according to the first time period and the second time period.

16. The method of claim 11, further comprising the step of storing, by the server computer, a plurality of user pattern data records comprising a plurality of events associated with a plurality of geographic locations.

17. The method of claim 16, further comprising the step of transmitting, by the server computer, at least one advertisement according to the user pattern data.

18. The method of claim 16, further comprising the step of transmitting, by the server computer, at least one customer service instruction according to the user pattern data.

19. The method of claim 11, further comprising the step of storing, by the server computer, a plurality of user biometric data records comprising a log of biometric data for the user.

20. The method of claim 19, further comprising the step of transmitting, by the server computer, a notification responsive to at least one of the plurality of biometric data records comprising an anomaly from an average within the plurality of biometric data records.
